(19) United States
(12) Patent Application Publication
(10) Pub. No.: US 2013/0091580 A1
(43) Pub. Date: Apr. 11, 2013

(54) Detect and Prevent Illegal Consumption of Content on the Internet

(71) Applicants: Davoud Maha, Sunnyvale, CA (US); Pravat Lall, Sunnyvale, CA (US); Brian Trombley, Cupertino, CA (US)

(72) Inventors: Davoud Maha, Sunnyvale, CA (US); Pravat Lall, Sunnyvale, CA (US); Brian Trombley, Cupertino, CA (US)

(73) Assignee: McAfee, Inc., Santa Clara, CA (US)

(21) Appl. No.: 13/270,275

(22) Filed: Oct. 11, 2011

(51) Int. Cl. G06F 21/24

(52) U.S. Cl. 726/26

(57) ABSTRACT

Disclosed are systems and methods for preventing (or at least deterring) a user from inadvertently or directly consuming illegal content on the Internet. For example, determine when a user might visit a site distributing illegal content (i.e., material in violation of a copyright or otherwise inappropriately distributed) and presenting a warning to the user prior to navigating to the identified inappropriate distribution site. Optionally, alternative distribution sites (i.e., an authorized distribution site) for the same or similar material can be presented to the user. For example, a user might be likely to visit an inappropriate distribution site when sent a message containing a link or when search results from a search engine query identify a plurality of distributors for a requested movie, song, book, etc. By informing a user of illegal sources and possible alternatives, a user can obtain the desired electronic distribution without violating an author's intellectual property rights.

### FIELD OF DISCLOSURE

This disclosure relates generally to a system and method for preventing a user from inadvertently or directly consuming illegal content on the Internet. More particularly, but not by way of limitation, this disclosure relates to systems and methods to determine when a user might be likely to visit a site distributing illegal content (Le., material in violation of a copyright or otherwise being inappropriately distributed) and presenting a warning to the user prior to navigating to the identified distribution site. Optionally, one or more alternative distribution sites (i.e., an authorized distribution site) for the same or similar material can be presented to the user.

### BACKGROUND

Today the Internet is viewed as a central hub for distributing information to consumers and employees. The Internet contains many sources of valid information and products from “authorized distributors” along with many sources of pirated information from unauthorized distributors. Pirated information includes, for example, information from the unauthorized distribution of videos, songs, software, games, and license cracking mechanisms.

Consumers and corporations need to be wary of downloading items that may come from unauthorized and/or disreputable download sources. There are many reasons for consumers and corporations to be concerned with downloading illegal content. One major reason for concern is possible violation of an Intellectual Property right and the potential cost ramifications (e.g., through litigation) associated with such a violation. A second major concern could relate to potential threats cause by some unauthorized distributions. For example, it is not uncommon for an unauthorized distribution of material on the Internet to include malicious material. The malicious material could simply be an inaccurate, but otherwise un-harmful, copy of the intended download. Alternatively, the malicious material could include items detrimental to a user or user's computer system environment. The detrimental items could take the form of malware, Trojan, virus, etc. or could, less obtrusively, contain a copy of software with embedded security holes or spyware to name a few. Because of these concerns and others, users may desire to have confidence that they are obtaining authorized and valid distributions of downloaded items.

To address the above mentioned concerns and others, this disclosure presents several embodiments of solutions or improvements to address preventing illegal consumption of content from the Internet.

### BRIEF DESCRIPTION OF THE DRAWINGS

FIG. 1 is a block diagram illustrating network architecture 100 according to one embodiment.

FIG. 2 is a block diagram illustrating a computer on which software according to one embodiment may be installed.

FIG. 3 is a block diagram of a Global Threat Intelligence (GTI) cloud and Internet distribution sources according to one embodiment.

FIG. 4 is a block diagram of a representation of the Internet, Authorized Distributors, and Content Requestors to illustrate one embodiment.

FIG. 5A is a flowchart illustrating a process for an Internet search for content according to one embodiment.

FIG. 5B is a flowchart illustrating a process for accessing Internet content from an embedded link according to one embodiment.

FIG. 5C is a flowchart illustrating a process for accessing Internet content from a directly typed universal resource locator (URL) according to one embodiment.

FIGS. 6-13 illustrate several possible screen presentations applicable to the processes of FIGS. 5A-C according to disclosed embodiments.

FIG. 14 illustrates a screen shot applicable to an embodiment similar to annotating information returned in an Internet search result, however this example illustrates how information and content links could be displayed on a social networking site.

### DETAILED DESCRIPTION

Various embodiments, described in more detail below, provide a technique for performing a check of a distribution source prior to allowing its content to be downloaded. The implementation could utilize a “cloud” of resources for centralized analysis. Individual download requests interacting with the cloud need not be concerned with the internal structure of resources in the cloud and can participate in a coordinated manner to distinguish potential threatening “rouge hosts” and “authorized distributions” on the Internet. For simplicity and clearness of disclosure, embodiments are disclosed primarily for a movie download. However, a user's request for a web page or content (such as an executable, song, video, software) could similarly be blocked or present a warning prior to satisfying the user's request. In each of these illustrative cases, internal networks and users can be protected from downloads (i.e., content) which may be considered outside of risk tolerances for the given internal network or user.

Also, this detailed description will present information to enable one of ordinary skill in the art of web and computer technology to understand the disclosed methods and systems for detecting and preventing illegal consumption of content from the Internet. As explained above, computer users download many types of items from the Internet. Downloaded items include songs, movies, videos, software, among other things. Consumers can initiate such downloads in a variety of ways. For example, a user could “click” on a link provided in a message (e.g., email, text or Instant Message (IM)). Alternatively, a user could perform a search in a web browser to locate material for download. Yet another option could be a user “clicking” (intentionally or unintentionally) on a pop-up style message that initiates a download. To address these and other cases systems and methods are described here that could inform the user prior to initiating an “illegal” download and optionally direct the user to alternative authorized distribution sites for the desired content. Business rules can be defined by users and/or administrators to define what is considered “illegal” for a given set of circumstances or machine.

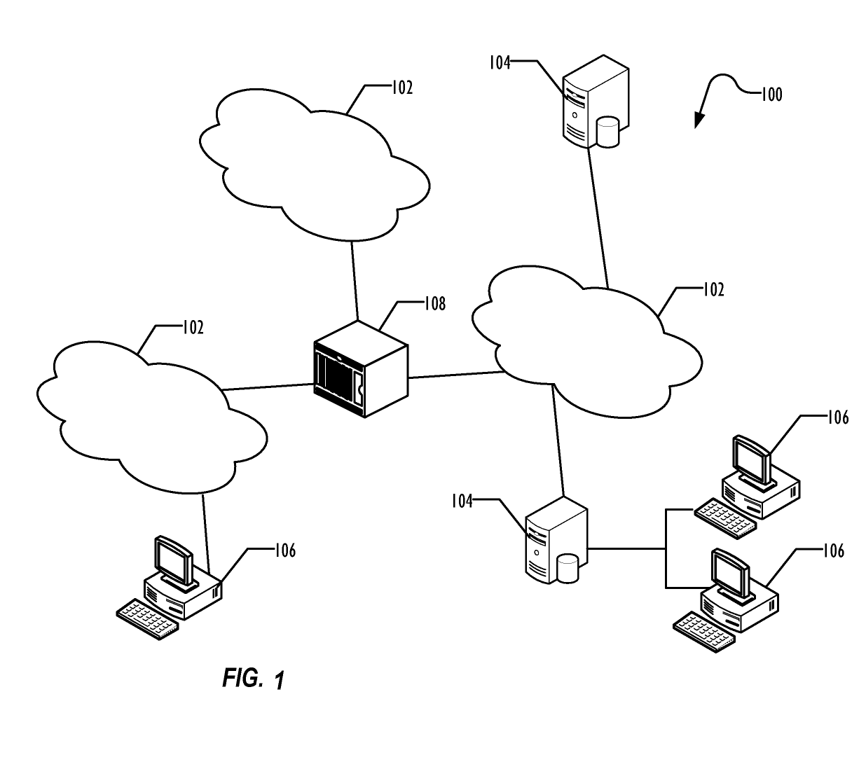

FIG. 1 illustrates network architecture 100, in accordance with one embodiment. As shown, a plurality of networks 102 is provided. In the context of the present network architecture 100, networks 102 may each take any form including, but not limited to a local area network (LAN), a wireless network, a wide area network (WAN) such as the Internet, etc.

Coupled to networks 102 are data server computers 104 which are capable of communicating over networks 102. Also coupled to networks 102 and data server computers 104 is a plurality of end user computers 106. Such data server computers 104 and/or client computers 106 may each include a desktop computer, lap-top computer, hand-held computer, mobile phone, peripheral (e.g. printer, etc.), any component of a computer, and/or any other type of logic. In order to facilitate communication among networks 102, at least one gateway or router 108 is optionally coupled there between.

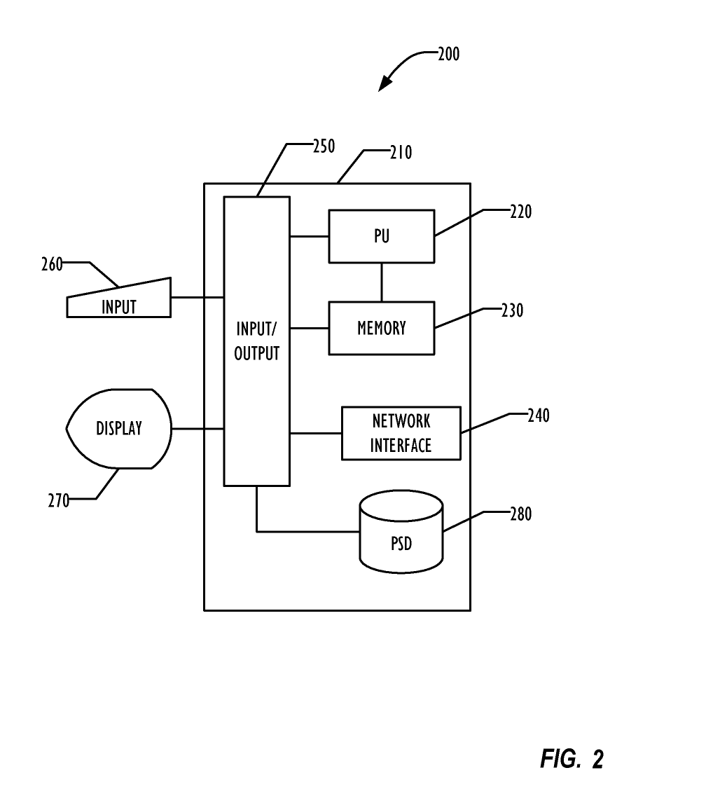

Referring now to FIG. 2, an example processing device 200 for use in providing a coordination of preventing illegal content download according to one embodiment is illustrated in block diagram form. Processing device 200 may serve as a gateway or router 108, client computer 106, or a server computer 104. Example processing device 200 comprises a system unit 210 which may be optionally connected to an input device for system 260 (e.g., keyboard, mouse, touch screen, etc.) and display 270. A non-transitory program storage device (PSD) 280 (e.g., a hard disc or computer readable medium) is included with the system unit 210. Also included with system unit 210 is a network interface 240 for communication via a network with other computing and corporate infrastructure devices (not shown). Network interface 240 may be included within system unit 210 or be external to system unit 210. In either case, system unit 210 will be communicatively coupled to network interface 240. Program storage device 280 represents any form of non-volatile storage including, but not limited to, all forms of optical and magnetic memory, including solid-state, storage elements, including removable media, and may be included within system unit 210 or be external to system unit 210. Program storage device 280 may be used for storage of software to control system unit 210, data for use by the processing device 200, or both.

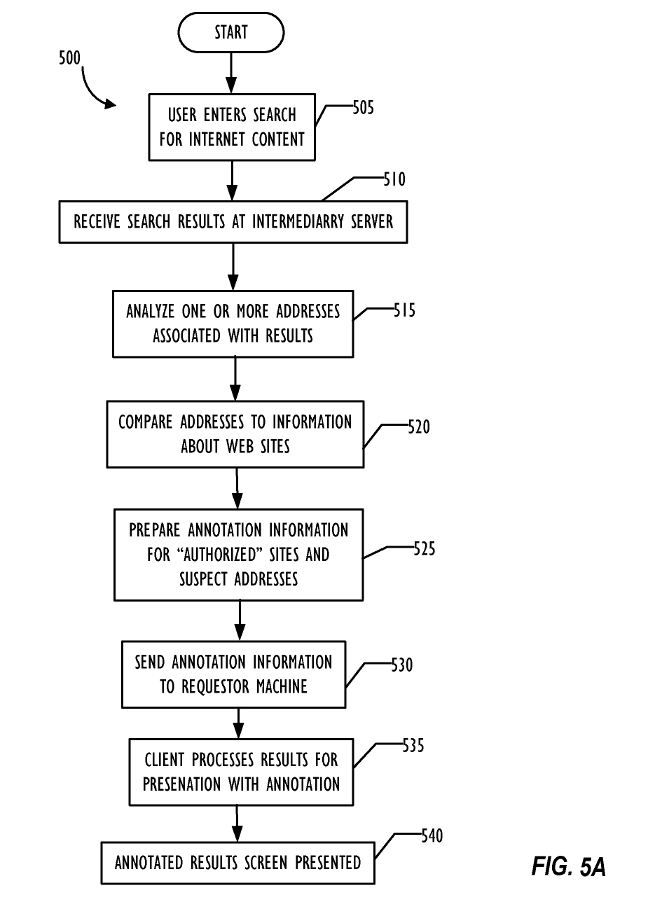

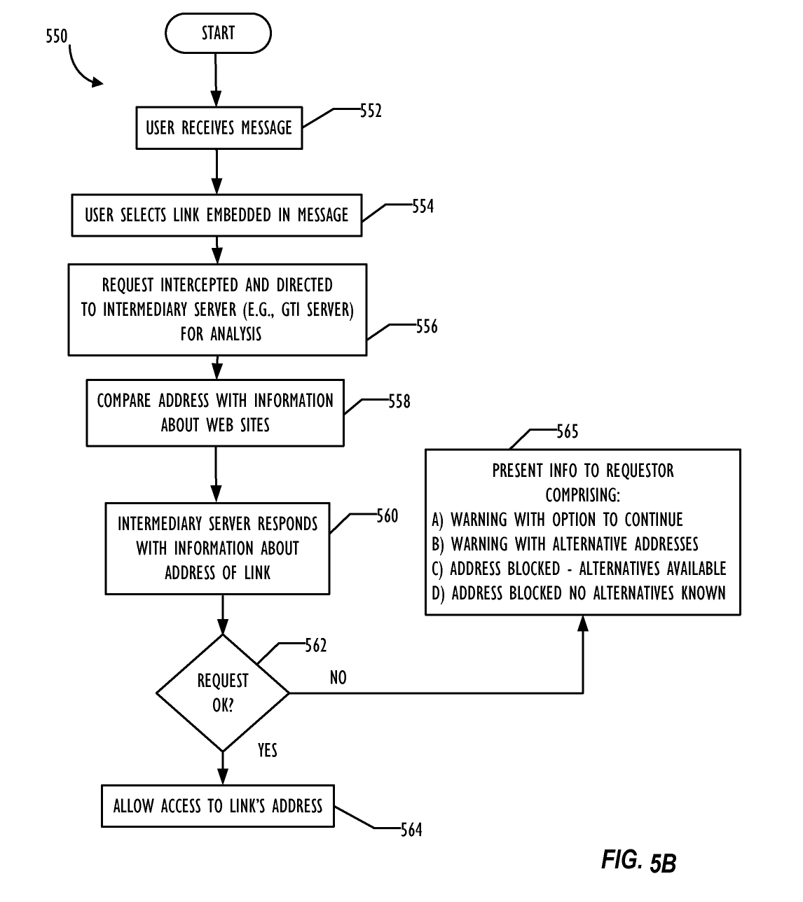

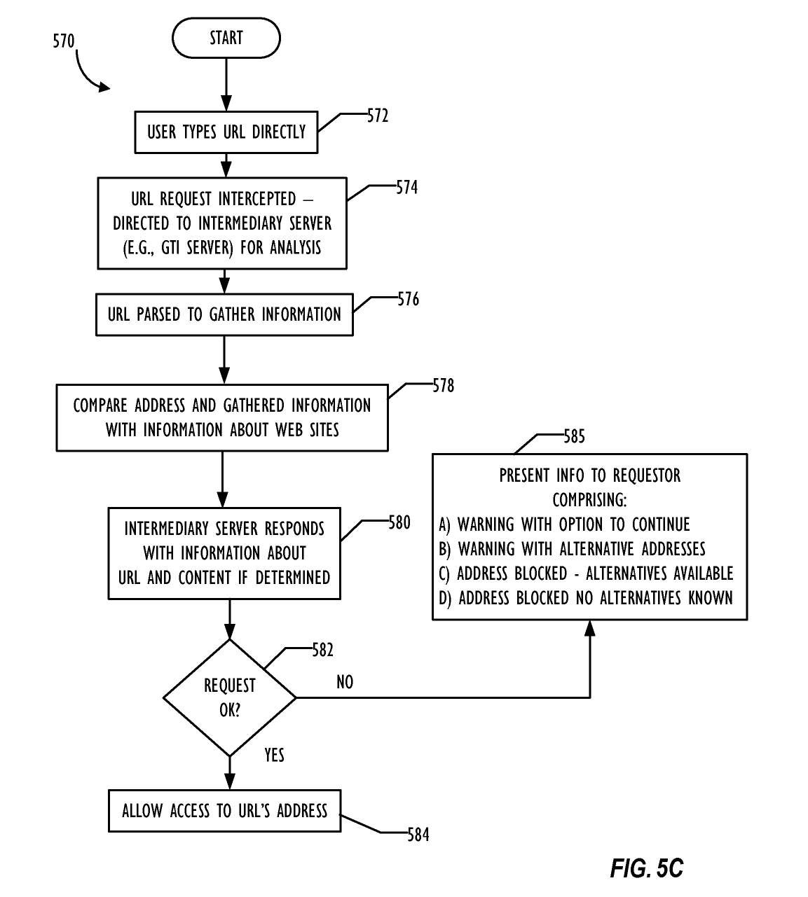

System unit 210 may be programmed to perform methods in accordance with this disclosure (an example of which are in FIGS. 5A-C). System unit 210 comprises a processor unit (PU) 220, input-output (I/O) interface 250 and memory 230. Processing unit 220 may include any programmable controller device including, for example, a mainframe processor, or one or more members of the Intel Atom®, Core®, Pentium® and Celeron® processor families from Intel Corporation and the Cortex and ARM processor families from ARM. (INTEL, INTEL ATOM, CORE, PENTIUM, and CELERON are registered trademarks of the Intel Corporation. CORTEX is a registered trademark of the ARM Limited Corporation. ARM is a registered trademark of the ARM Limited Company). Memory 230 may include one or more memory modules and comprise random access memory (RAM), read only memory (ROM), programmable read only memory (PROM), programmable read-write memory, and solid-state memory. PU 220 may also include some internal memory including, for example, cache memory.

Processing device 200 may have resident thereon any desired operating system. Embodiments may be implemented using any desired programming languages, and may be implemented as one or more executable programs, which may link to external libraries of executable routines that may be provided by the provider of the illegal content blocking software, the provider of the operating system, or any other desired provider of suitable library routines. As used herein, the term “a computer system” can refer to a single computer or a plurality of computers working together to perform the function described as being performed on or by a computer system.

In preparation for performing disclosed embodiments on processing device 200, program instructions to configure processing device 200 to perform disclosed embodiments may be provided stored on any type of non-transitory computer-readable media, or may be downloaded from a server 104 onto program storage device 280.

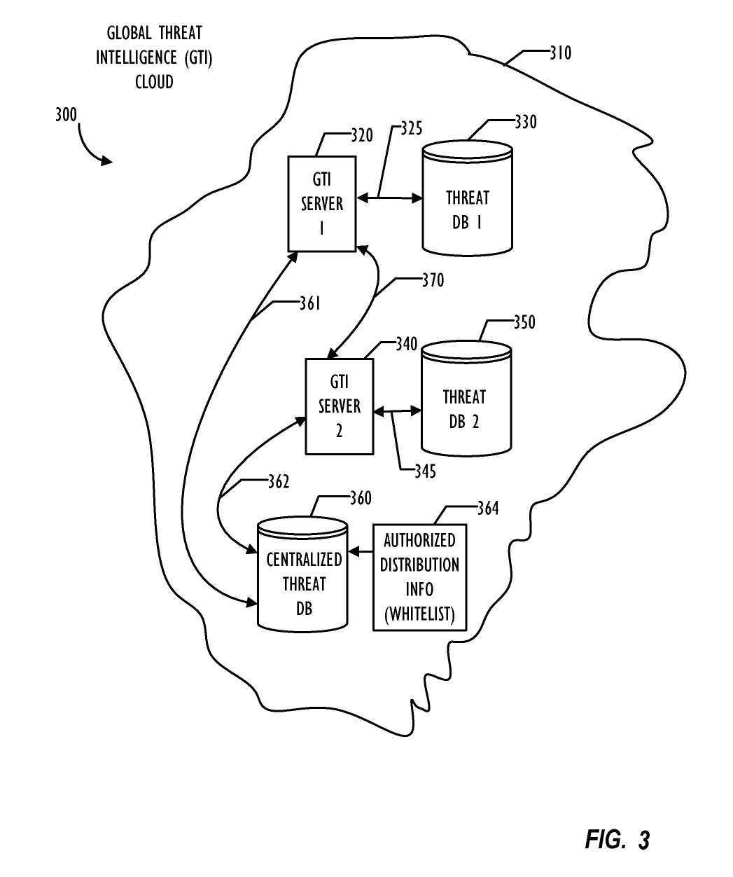

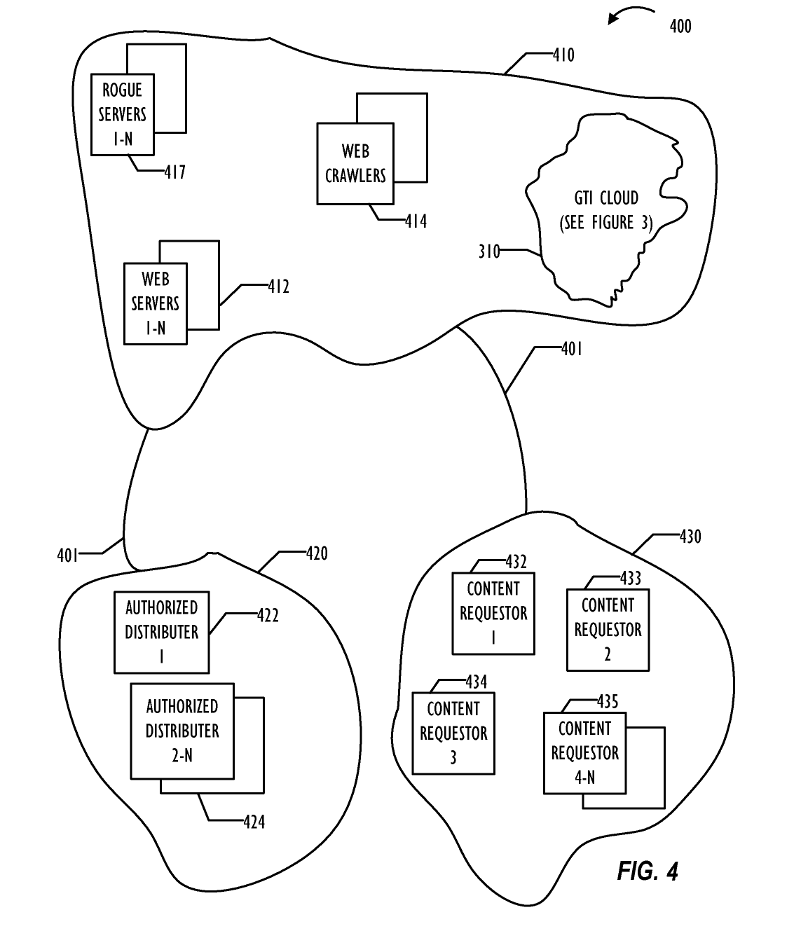

Referring now to FIG. 3, a block diagram 300 illustrates one example of a GTI cloud 310. A GTI cloud 310 can provide a centralized function for a plurality of clients (sometimes called subscribers) without requiring clients of the cloud to understand the complexities of cloud resources or provide support for cloud resources. Internal to GTI cloud 310, there are typically a plurality of servers (e.g., Server 1 320 and Server 2 340). Each of the servers is, in turn, typically connected to a dedicated data store (e.g., 330 and 350) and possibly a centralized data store, such as Centralized DB 360. Each communication path is typically a network or direct connection as represented by communication paths 325, 345, 361, 362 and 370. Although diagram 300 illustrates two servers and a single centralized database, a comparable implementation may take the form of numerous servers with or without individual databases, a hierarchy of databases forming a logical centralized database, or a combination of both. Furthermore, a plurality of communication paths and types of communication paths (e.g., wired network, wireless network, direct cable, switched cable, etc.) could exist between each component in GTI cloud 310. Such variations are known to those of skill in the art and, therefore, are not discussed further here. Also, although disclosed herein as a cloud resource, the essence of functions of GTI cloud 310 could be performed, in an alternate embodiment, by conventionally configured (i.e., not cloud configured) resources internal to an organization.

To facilitate content blocking and authorized distribution information, GTI cloud 310 can include Authorized Distribution Information as discovered by web crawlers or provided in a “whitelist” 364 provided by authorized content providers. The whitelist could list address information (e.g., IP addresses, hostnames, domain names, etc.) so that services provided by GTI cloud 310 could be augmented with pre-determined good information. Additionally, web crawlers or a “blacklist” (not shown) could identify a list of dis-allowed hosts from which content downloads should be discouraged or blocked. Also, Internet content can be categorized into content types including, but not limited to, news (breaking, international, local, financial), entertainment, sports, music (rap, classical, rock, easy listening), etc. The content type can be used by both administrators and users to further configure how potential downloads can be handled (i.e., different by category).

Referring now to FIG. 4, block diagram 400 illustrates a plurality of user types (420 and 430) connected by connection links 401 to Internet 410 and to each other (via Internet 410). User types 420 and 430 represent (for the purposes of this example) two distinct sets of users (e.g., consumers 410 and providers 420). Consumer group 410 includes a plurality of content requestors (e.g., 432-435) which may request content from providers in a number of different ways. For example, Content Requestor 1 (432) may provide a search request to a search engine; Content Requestor 2 (433) may select an embedded link in a received message; Content Requestor 3 (434) may type an address (e.g., universal resource locator URL) directly into a web browser or file transfer interface; and Content Requestors 4-N (435) represent other types of requests. An example process flow for requests of types 1-3 are outlined below with reference to FIGS. 5A-C. Group 420 illustrates a simplified view of Authorized Distributors (422 and 424) which provide authentic and trustworthy content to Internet consumers (i.e., group 430) via web servers such as 412 connected to Internet 410.

Internet 410 illustrates a greatly simplified view of the actual Internet. Internet 410 includes a plurality of web crawlers 414, a plurality of web servers 1-N 412, potential rogue servers 1-N 417, and GTI cloud 310 from FIG. 3. As is known to those of ordinary skill in the art, each of the servers in Internet 410 would have a unique address and identification information with some of the servers being legitimate servers and other servers providing unauthorized content (referred to here as rogue servers 417) potentially hosting illegal and possibly harmful content. Rogue servers may appear genuine to unwary consumers because there may be nothing obviously illegal about their presentation of content. Web crawlers 414 represent servers that generally continually “crawl” the web to gather information about web sites on Internet 410. Web crawlers 414 can be configured to identify material made available for download that is likely to be subject to copyright protection and provide information about the hosting sites for further analysis. Once analyzed, either automatically or manually, the information gathered by web crawlers 414 can be added to the information about web sites known to GTI cloud 310.

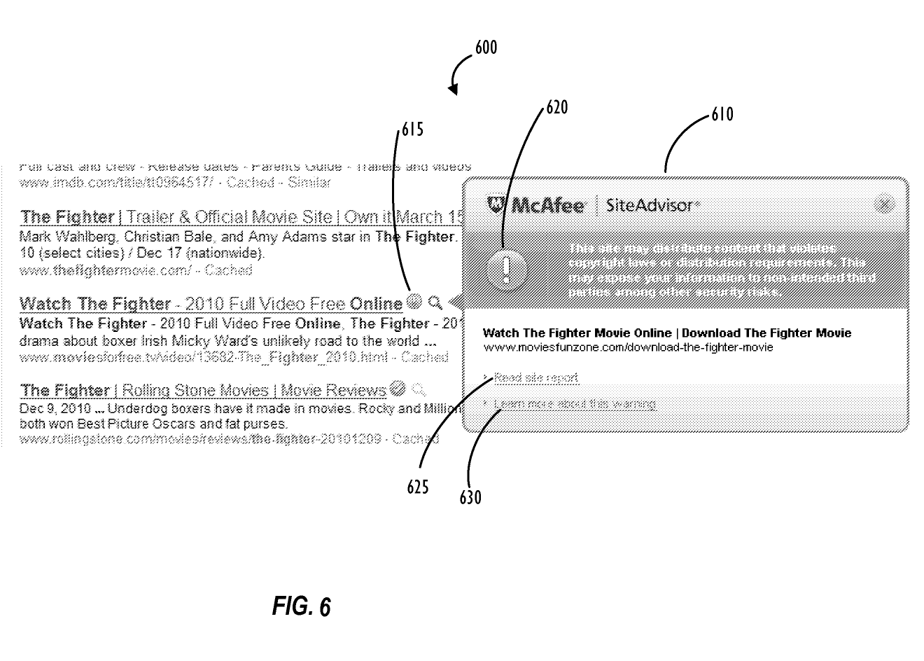

Referring now to FIGS. 5A-C, processes 500, 550 and 570 illustrate example processes flows for an Internet content request according disclosed embodiments. Example screen shots to illustrate aspects of these process flows are explained below in the context of FIGS. 6-13.

Process 500 is illustrated in FIG. 5A. Beginning at block 505, a user enters a search for Internet content. The search terms can be used to provide a context of the type of information a user is looking for. For example, a user at a client computer might enter terms “fighter movie” to mean a request for a movie download (Internet content) with the title fighter. Because movies, songs, books and software represent types of data generally available from unauthorized distributors, this type of search represents a type that should be further analyzed. The search query's results can be intercepted (either before or concurrent with responding to the requesting client) and sent to an intermediary server (block 510) such as GTI cloud 310 for further analysis. At GTI cloud 310 (or a server configured to perform a similar function), the search results analysis (block 515) can assist in determining authorized and unauthorized distribution sites for the requested movie. GTI cloud 310 can compare results information with information about known web-sites (block 520). The information about known web sites can include information from whitelists, blacklists and information determined by web crawling. At block 525, GTI cloud 310 can prepare annotation information for authorized sites identified in the search results as well as warnings and warning information about unauthorized sites also identified in the search results. The information prepared at block 525 can then be sent to the client machine that originally requested the search (block 530). The client machine having already received the search results (or receiving the search results combined with the annotation information) can process the results and annotation information to prepare a results screen for display (block 535). Finally, at block 540 a results screen comprising search results and corresponding annotations can be presented on the client machine.

Process 550 is illustrated in FIG. 5B. Beginning at block 552, a user receives a message at a first client machine (e.g., email, IM, text, etc.) with an embedded link to represent a potential content download. At block 554, the user selects the link embedded in the message to indicate a desire to download the referred to content. Next, at block 556, the request generated as a result of the link's selection can be intercepted and redirected to an intermediary server (e.g., GTI cloud 310) for analysis prior to initiating the actual download. As part of the analysis the address referenced in the selected link can be compared with information about web sites (558). One difference between process 550 and process 500 is that a user selecting a link may or may not provide as much “context” for analysis. For example, to determine that the embedded link points to a movie can be determined from the file type referenced in the link but the title of the movie may not be as easily discernible. To aid in providing further context, the context for assistance in identifying possible alternatives, the URL of the link the link can be parsed, information available at the server hosting the content of the URL may be gathered, or the message containing the link may be parsed. If additional context can be determined, the additional context can be used at the intermediary server when locating possible alternative sites. Next, at block 560, the intermediary server can respond to the link selection request with information about the address referenced by the link. If it is determined the link's address is associated with an authorized distribution site (YES prong of 562) then access to the link and initiation of content download can commence without additional user interaction (block 564). However, if the requested information is determined to come from a suspect or questionable site (the NO prong of 562) then a user can be presented with a variety of information (block 565). The variety of information can be configured by user and/or administrator preference settings as determined appropriate for the type of the first client machine (e.g., corporate, personal, secured access, etc.). Options to present to the user include a warning with an option to continue to the suspect address; a warning with possible alternative addresses that may be known to contain authorized versions of the content referenced; a block of the link's address with a list of possible non-blocked alternatives; or a block of the link's address with no known alternative distribution sites. Variations and combinations of these and other potential options for a user are also possible.

Process 570 is illustrated in FIG. 5C. Beginning at block 572, a user types in a URL address directly to request a potential content download. At block 574, the request generated can be intercepted and redirected to an intermediary server (e.g., GTI cloud 310) for analysis prior to initiating the actual download. As part of the analysis the address referenced in the typed in URL link can be parsed (576) and compared with information about web sites (578). One difference between process 570 and processes 500 and 550 is that a user typing in a URL directly may provide the least amount of “context” for analysis. Therefore, methods described above may be used to the extent possible to gather context information for assistance in identifying possible alternatives. If additional context can be determined, the additional context can be used at the intermediary server when locating possible alternative sites. Next, at block 580, the intermediary server can respond to the URL download request with information about the address referenced by the URL. If it is determined the link's address is associated with an authorized distribution site (YES prong of 582) then access to the link and initiation of content download can commence without additional user interaction (block 584). However, if the requested information is determined to come from a suspect or questionable site (the NO prong of 582) then a user can be presented with a variety of information (block 585). The variety of information can be similar to that described above for block 565 of FIG. 5B.

Referring now to FIGS. 6-13, example screen shots are shown for computers and mobile devices configured according to processes 500, 550 and 570. FIG. 6 illustrates screen shot 600 which represents a portion of a screen of search results as might be presented by an Internet search engine. Icon 615 shows an exclamation point (Le., “!”) to indicate that the corresponding link may not contain authorized distribution material. Dialog (or balloon style pop up) 610 provides more information about the suspect link. Dialog 610 may be presented responsive to a user hovering over warning Icon 615. Dialog 610 contains a warning symbol 620 corresponding to the warning of Icon 615 and provides a link 625 to read a site report and link 630 to learn more information about the particular warning or warning type.

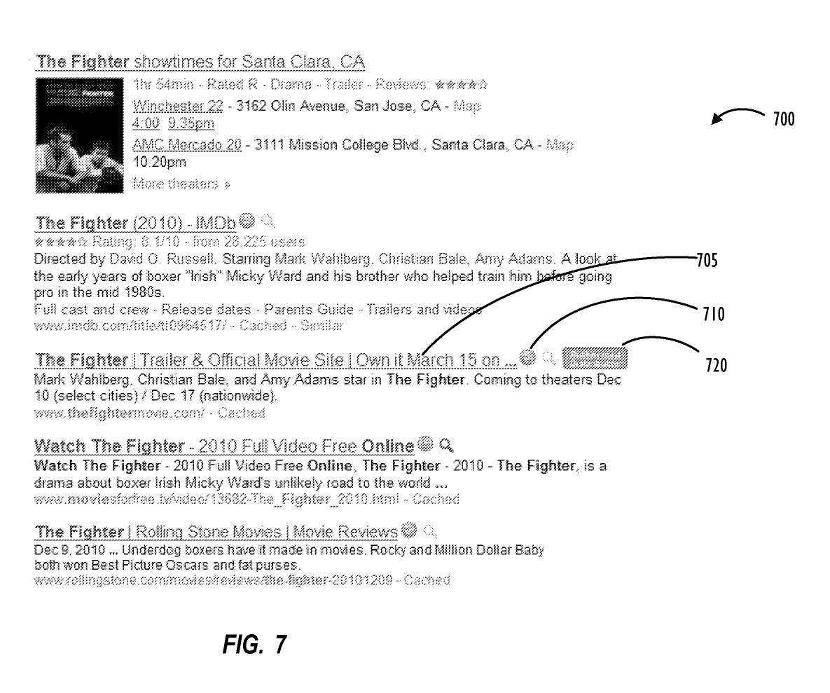

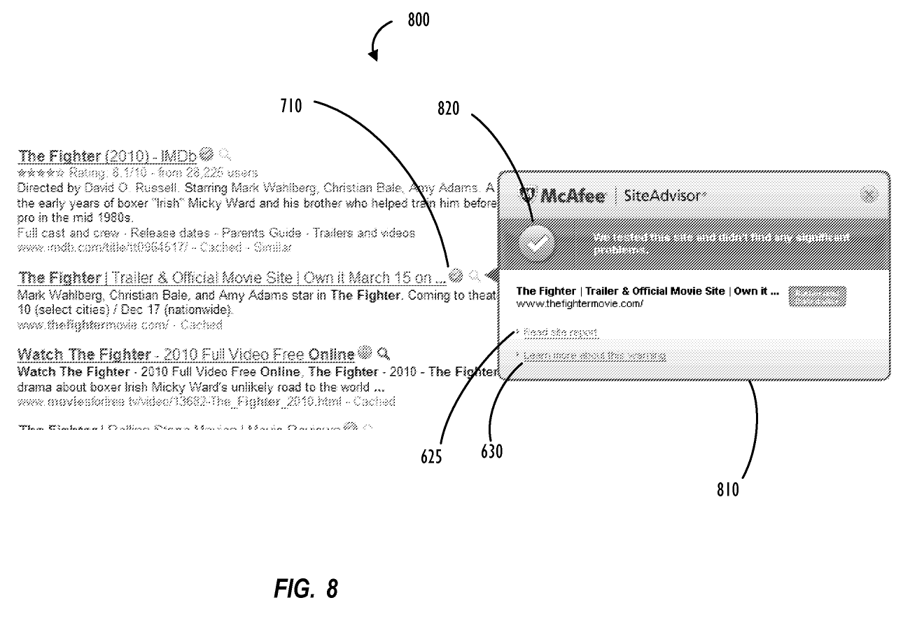

FIG. 7 illustrates screen shot 700 which represents a different portion of a screen shot corresponding to search results similar to screen shot 600. In this case, link 705 represents a link to a known authorized distributor. Icon 710 reflects a green check symbol to indicate the content referenced by link 705 has passed screening and Annotation 720 explains to a user that corresponding content is from an “Authorized Distributor.” FIG. 8 shows screen shot 800 which illustrates dialog 810 and its internal symbol 820. Dialog 810, which again may be a balloon style pop up, corresponds to Icon 710 and provides further information to a user when the user hovers to indicate a desire for additional information. Again, dialog 810 contains links 625 and 630 for even further information.

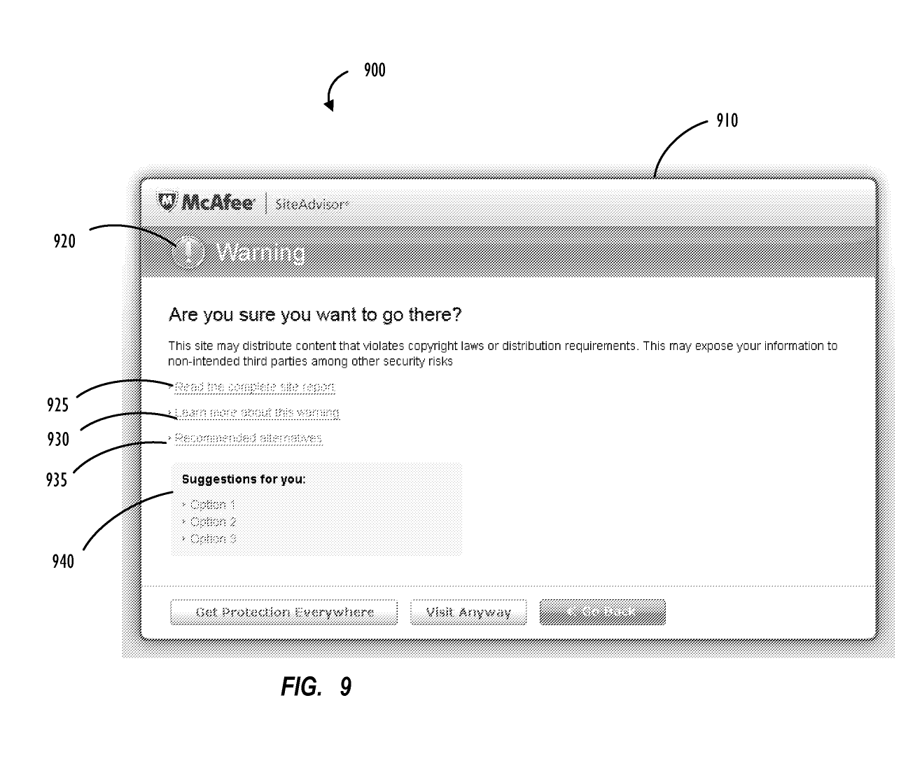

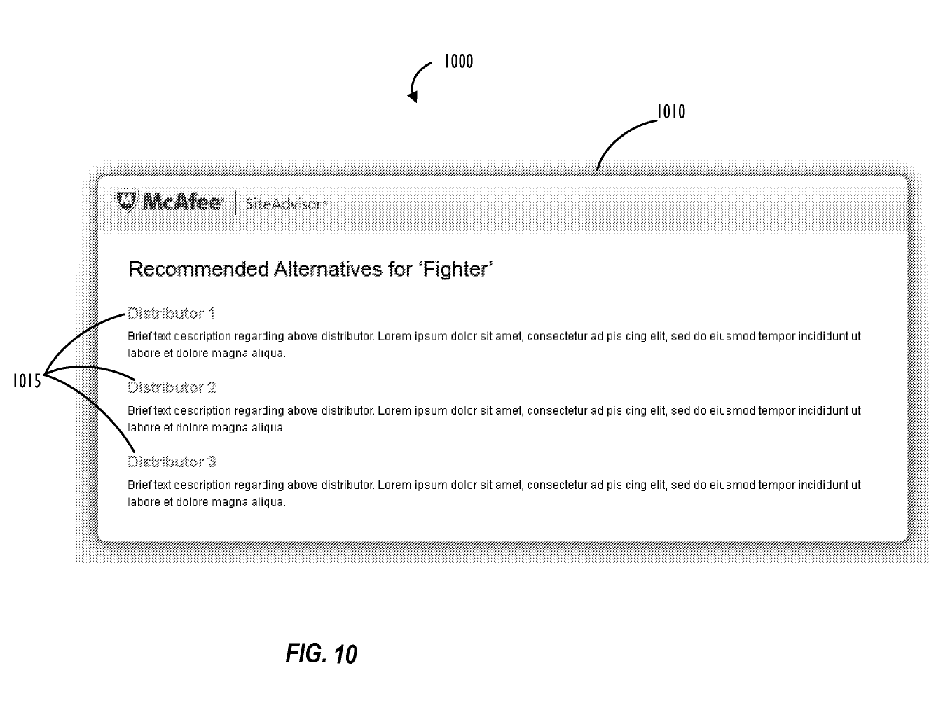

FIG. 9 illustrates an interstitial page 900 that can be presented to a user when the user is accessing a link more directly than through a search results screen (e.g., process 550 or 570). Screen pop up 910 can be presented with an indicator Icon such as warning Icon 920, a link to a complete report 925, an informational link about the warning itself 930, a link to request recommended alternatives 935, and a possible suggested alternatives derived as possible (with limited context) in section 940. If a user desires additional alternatives for a blocked request from this type of interstitial page, the user can select recommended alternatives 935. The user can then possibly provide additional information (e.g., more context) about the desired content to assist in locating alternative authorized distribution sites. However, if valid alternatives are already determined, selection of recommended alternatives 935 can present screen 1000 of FIG. 10 which shows dialog 1010. Dialog 1010 contains examples of a plurality of authorized distributors (links 1015) and a short description of each of the distributors.

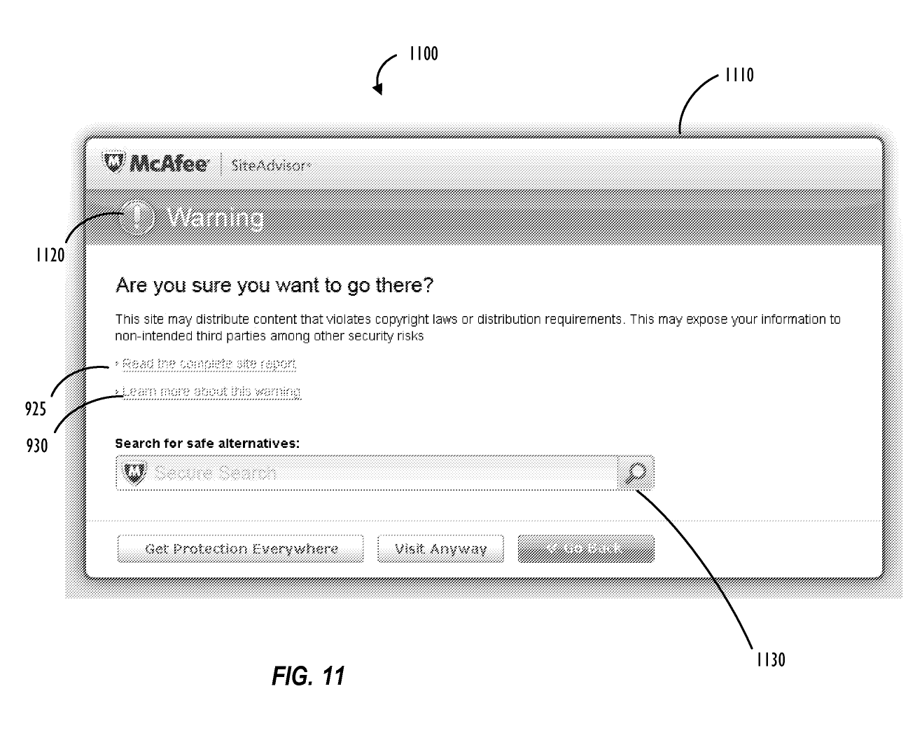

FIG. 11 illustrates warning dialog 1110, again with a warning Icon 1120 and links 925 and 930. Additionally, dialog 1110 displays a search for safe alternatives entry location 1130 to allow a user to enter a search complete with context to find the desired content from an authorized distributor.

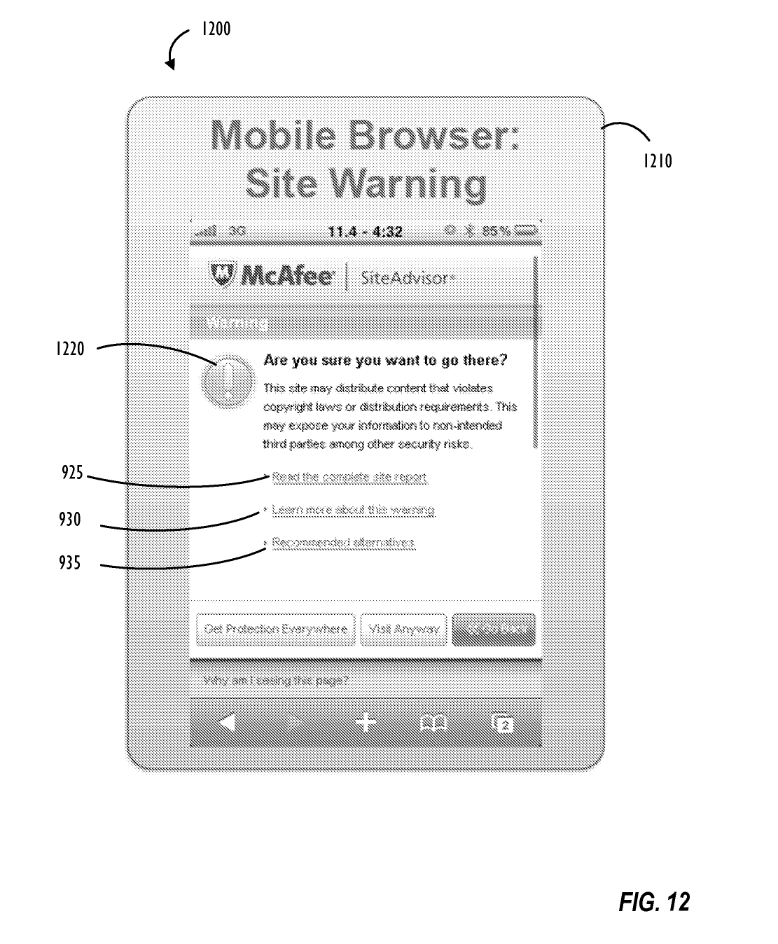

FIG. 12 illustrates screen shot 1200 containing screen portion 1210 and warning Icon 1220 as it might be presented on a Mobile devices browser. Screen shot 1200 is similar in nature to screen shot 900 described above and also contains links 925, 930 and 935.

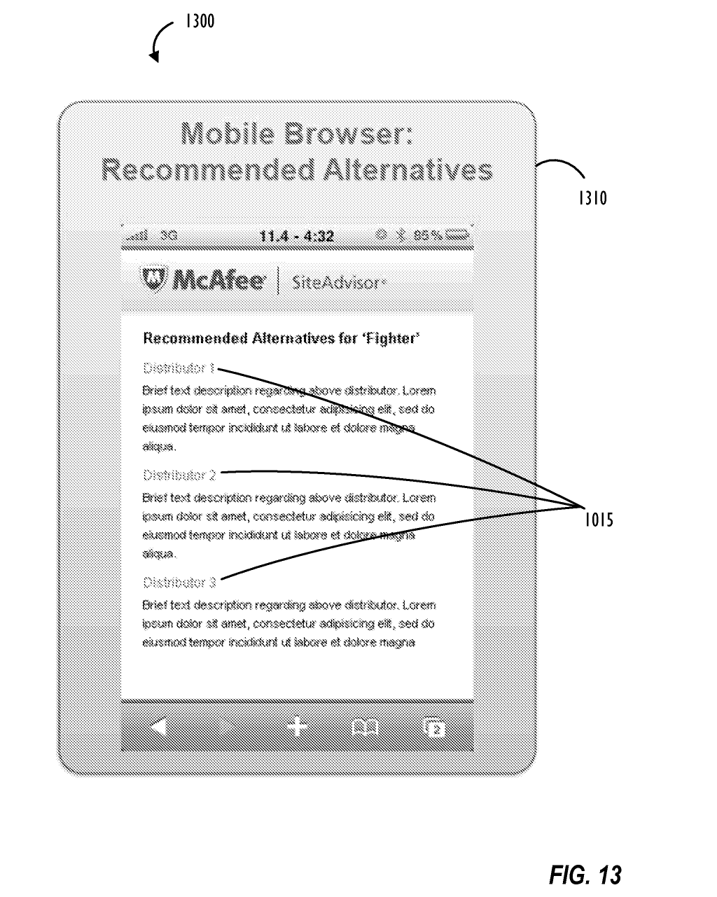

FIG. 13 illustrates screen shot 1300 containing screen portion 1310 as it might be presented on a Mobile devices browser. Screen shot 1300 is similar in nature to screen shot 1100 and contains links 1115 for alternate distributers.

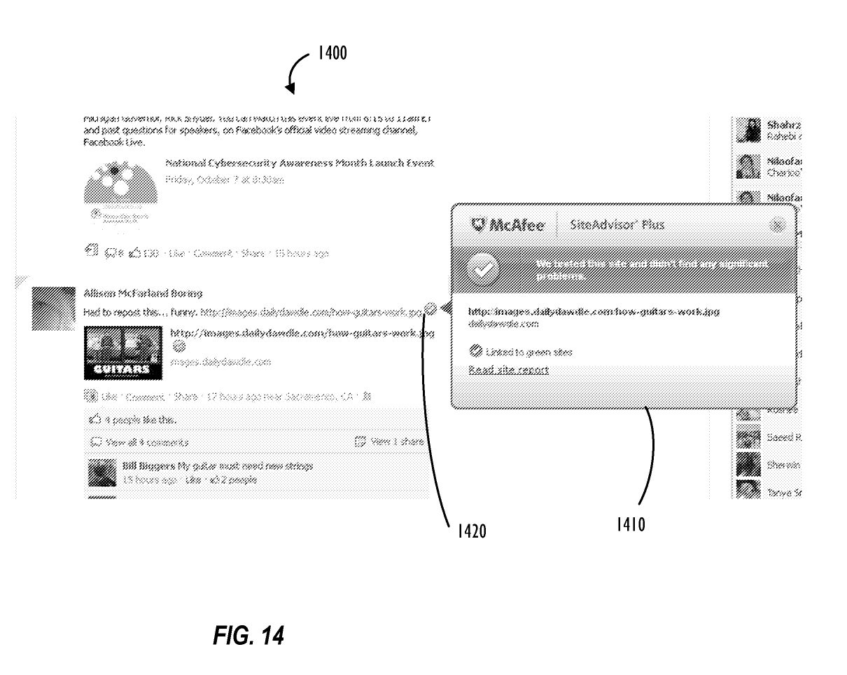

Referring now to FIG. 14 which illustrates screenshot 1400. In a similar manner to annotating information on a web browsers search results screen, a user's screen access to a social networking site such as Facebook or LinkedIn (Facebook is a trademark of Facebook Inc. and LinkedIn is a trademark of LinkedIn Ltd) could also be annotated. The annotations and information about illegal content distribution and blocking could be implemented in a manner similar to that described above. For example, a user selecting a link presented on a social media site could be intercepted by an intermediary server such as GTI cloud 310 and annotation icons (1420) with hover pop up balloons (1410) could be presented along with content links to users accessing social media sites. The annotations, of course, could be presented prior to an actual selection by an end user. Screen shot 1400 illustrates one example of how this might appear to a user.

As should be apparent from the above explanation, embodiments disclosed herein allow the user, the intermediate server, web crawlers and distributors to work together to detect and prevent illegal consumption of content from the Internet. Also, in the embodiments specifically disclosed herein, the content object of the example comprises a movie; however other types of objects are contemplated and could benefit from concepts of this disclosure. It may also be worth noting that both the identification of a rogue host and the blocking of a rogue host may be applied to more than just URLs, links and search results, any number of IP technologies could be included, FTP/HTTP/VOIP/IM(Instant Messaging).

In the foregoing description, for purposes of explanation, numerous specific details are set forth in order to provide a thorough understanding of the disclosed embodiments. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

It is also to be understood that the above description is intended to be illustrative, and not restrictive. For example, above-described embodiments may be used in combination with each other and illustrative process steps may be performed in an order different than shown. Many other embodiments will be apparent to those of skill in the art upon reviewing the above description. The scope of the invention therefore should be determined with reference to the appended claims, along with the full scope of equivalents to which such claims are entitled. In the appended claims, terms “including” and “in which” are used as plain-English equivalents of the respective terms “comprising” and “wherein.”

What is claimed is:

1. A computer system configured to analyze an Internet request for content, the computer system comprising:
a processor; and
a memory, storing information known about web sites, communicatively coupled to the processor wherein the processor is configured to:
receive a first client's request for content, the request indicating content to download from an identifiable Internet host and a first address for the identifiable Internet host;
analyze the address for the content with respect to the information known about web sites;
determine the first address represents an unauthorized distribution site for the request;
identify one or more second addresses associated with authorized distribution sites for the request;
prepare a response message responsive to the request, the response message comprising at least one of the identified one or more second addresses, wherein the one or more second addresses are different from the first address; and
send the response message to the first client.

2. The computer system of claim 1, wherein the information known about web sites comprises whitelist information, the whitelist information indicating authorized distribution locations.

3. The computer system of claim 1, wherein the information known about web sites comprises blacklist information, the blacklist information indicating unauthorized distribution locations.

4. The computer system of claim 1, wherein the information known about web sites comprises information automatically obtained by web crawlers.

5. The computer system of claim 1, the processor configured to identify one or more second addresses associated with authorized distribution sites for the request is further configured to retrieve additional context information from the unauthorized distribution site at the first address.

6. The computer system of claim 1, the processor configured to identify one or more second addresses associated with authorized distribution sites for the request is further configured to retrieve additional context information from available information related to the first client's request for content.

7. The computer system of claim 6, wherein the available information related to the first client's request for content comprises information identified in a message containing an embedded link, the embedded link associated with the first client's request for content.

8. The computer system of claim 6, wherein the first client's request for content comprises only an indication of a universal resource locator (URL).

9. A computer system configured to analyze an Internet search for content, the computer system comprising:
a processor; and
a memory, storing information known about web sites, communicatively coupled to the processor wherein the processor is configured to:
receive information pertaining to a search request for first Internet content, the search request from a first client;
receive information pertaining to a search result, the search result responsive to the search request;
determine augmentation information for one or more addresses reflected in the information pertaining to a search result, the augmentation information identifying at least one address associated with an unauthorized distributor of the first Internet content;
send the augmentation information to the first client.

10. The computer system of claim 9, wherein the augmentation information and the search results responsive to the search request are merged together prior to sending to the first client.

11. The computer system of claim 9, wherein the augmentation information comprises information identifying at least one search result as an authorized distributor and a second search result as a suspect distributor.

12. The computer system of claim 11, wherein the suspect distributor comprises an unauthorized distributor.

13. The computer system of claim 9, wherein the augmentation information comprises information identifying at least one alternative and authorized source for content requested associated with an identified unauthorized distributor search result.

14. The computer system of claim 9, wherein the processor is further configured to determine augmentation information based on a category type of content identified in the search result.

15. A computer system configured to analyze a response to an Internet search for content, the computer system comprising:
a processor; and
a memory, storing information about a search response, communicatively coupled to the processor wherein the processor is configured to:
request first Internet content via an Internet search;
receive a response to the Internet search;
receive augmentation information related to the response to the Internet search, the augmentation information identifying at least one address associated with an unauthorized distributor of the first Internet content;
prepare a results screen containing annotated results information, the annotated results information determined from at least a portion of the augmentation information.

16. The computer system of claim 15, wherein the processor is further configured to present additional information corresponding to an annotation icon responsive to an indication of selection of an annotation icon.

17. The computer system of claim 15, wherein the indication of selection comprises a hover operation over the annotation icon.

18. The computer system of claim 16, wherein the additional information corresponding to an annotation icon is presented in a balloon style pop-up.

19. The computer system of claim 15, wherein the augmentation information is processed into annotation information for corresponding links presented on a display device.

20. A non-transitory computer readable medium comprising instruction stored thereon to configure a processor to:
receive a first client's request for content, the request indicating content to download from an identifiable Internet host and a first address for the identifiable Internet host;
analyze the address for the content with respect to information known about web sites;
determine the first address represents an unauthorized distribution site for the request;
identify one or more second addresses associated with authorized distribution sites for the request;
prepare a response message responsive to the request, the response message comprising at least one of the identified one or more second addresses, wherein the one or more second addresses are different from the first address; and
send the response message to the first client.

21. A non-transitory computer readable medium comprising instruction stored thereon to configure a processor to:
receive information pertaining to a search request for first Internet content, the search request from a first client;
receive information pertaining to a search result, the search result responsive to the search request;
determine augmentation information for one or more addresses reflected in the information pertaining to a search result, the augmentation information identifying at least one address associated with an unauthorized distributor of the first Internet content;
send the augmentation information to the first client.

22. A non-transitory computer readable medium comprising instruction stored thereon to configure a processor to:
request first Internet content via an Internet search;
receive a response to the Internet search;
receive augmentation information related to the response to the Internet search, the augmentation information identifying at least one address associated with an unauthorized distributor of the first Internet content;
prepare a results screen containing annotated results information, the annotated results information determined from at least a portion of the augmentation information.
